(19) United States
(12) Patent Application Publication
(10) Pub. No.: US 2026/0192585 A1
(43) Pub. Date: Jul. 9, 2026

(54) METHODS AND APPARATUS FOR CONTROLLING A PRINTHEAD

(71) Applicant: Dover Europe Sàrl, Vernier (CH)

(72) Inventor: Mohammed Toudmeri, Nottingham (GB)

(21) Appl. No.: 19/128,190

(22) PCT Filed: Nov. 8, 2023
(86) PCT No.: PCT/EP2023/081231

§ 371 Date: May 8, 2025

(30) Foreign Application Priority Data
Nov. 8, 2022 (GB) 2216643.3

(51) Int. Cl. B41J 25/316; B41J 2/325; B41J 11/00; B41J 25/00; B41J 29/00; B41J 33/14

(52) U.S. Cl. CPC B41J 25/316; B41J 2/325; B41J 11/008; B41J 25/001; B41J 29/00; B41J 33/14

(57) ABSTRACT

A printing apparatus including a printhead and a printhead movement arrangement, the printhead movement arrangement including a belt moveable in a belt path, and a linkage between the printhead and the belt, wherein the linkage is attached to the belt at a first belt position and a second belt position, the printhead movement arrangement being configured such that the printhead is moveable angularly as a result of linear movement of at least one portion of the belt in the belt path and a method of operation of such a printing apparatus.

### FIELD

The present invention relates to improvements to a printing apparatus and methods of controlling a printhead in a printing apparatus. In particular, the invention can be applied to thermal transfer over-printers (TTO).

### BACKGROUND

Transfer printing is well known in the art of commercial printing. In the field of thermal transfer printing, a reel of inked ribbon (also called ‘tape’) is typically mounted onto a spool support. The ink carrying ribbon is transferred along a ribbon path from the supply spool, to the take up spool in a ribbon path, past a printhead which is operable to transfer ink from the ribbon to a substrate. The printhead may include a plurality thermally energisable (heatable) printing elements or pixels, which are operable to warm the ink on the ribbon such that it can be removed from the ribbon and transferred to the substrate to form an image, for example data, a pattern, a bar code, QR code, etc., One or both of the supply spool and the take up spool are typically driven in order to transfer the ribbon between the spools. The spool support may be rotatable to transfer ribbon from the first (supply) spool to a second (take up) spool into which ribbon may be wound after/during use. The second spool support may also be rotatable. Various methods of operation of such a reel to reel ribbon drive are known in the art. Ribbon is typically transferrable between the pair of spools in both directions, but generally speaking, as ink is removed from the ribbon during successive printing operations, the used ribbon is wound onto the second “take-up” spool, such that the diameter of the supply spool decreases and the diameter of the take-up spool increases. The ribbon can typically be moved in two directions between the spools, i.e., in a forward direction and reverse direction. The substrate on to which ink is to be transferred during a printing operation is typically moveable relative to the printhead.

As the inked ribbon is moved through the printing apparatus (between the spool supports), it is passed under the printhead (and the heating elements). The inked ribbon is sandwiched between the printhead and a substrate on which an image is to be printed. One or more heating elements are heated to melt a portion of ink on the ribbon and it is transferred to the substrate to print. There are two principal operating modes-intermittent printing and continuous printing. In intermittent printing, the substrate is advanced to a printing position near to the printhead and then stops, the printhead is then moved relative to the substrate to transfer ink from the ribbon to the substrate to create an image. The substrate then advances to a next printing position. This printing operation process is typically repeated until all required printing operations have been completed, and/or the inked ribbon is depleted and/or the substrate is depleted. In continuous printing, the substrate moves substantially continuously in a substrate path relative to the printhead, whilst the printhead remains in a substantially fixed position (in the direction of the substrate path) relative to a substrate support. In both intermittent and continuous printing modes, the printhead typically moves towards and away from the ribbon and the substrate, between a non-printing position, in which the printhead is not in contact with the ribbon (or at least not sufficiently close to be able to transfer ink from the ribbon) and a printing position, in which the printhead is in contact with the ribbon (or at least is close enough to transfer ink from the ribbon).

The printhead is typically moveable substantially orthogonally to the direction of ribbon travel between a retracted or “park” (non-printing) position, a ready-to-print or “prime” (non-printing) position which is closer to the ribbon than the retracted position, and a printing position, in which the printhead is in contact with the ribbon. In the printing position, the printhead bears against a substrate support, pressing the ribbon into contact with the substrate to transfer ink from the ribbon to the substrate.

Typically, a pneumatic actuator has been used to move the printhead between its deployed printing position, and its retracted position. The time taken to move from between the prime position and the printing position is typically very short, for example less than 20 milliseconds.

Apart from the infrastructure requirement to deliver compressed air, various studies have shown that efficiency of compressed air systems is in the range of 10% to 15%. Consequently, compressed air actuators are deemed to be more expensive to run in comparison with electrical ones. While there is a high demand for cost-effective actuators, the compressed air solution restricts the TTO (thermal transfer overprinting) market to those factories having compressed air facilities.

Embodiments relating to the present disclosure seek to alleviate one or more of the problems associated with known systems.

### BRIEF DESCRIPTION OF THE INVENTION

There is provided a printing apparatus including a printhead movement arrangement, the printhead movement arrangement including a belt moveable in a belt path, and a linkage between the printhead and the belt, wherein the linkage is attached to the belt at a first belt position and a second belt position, the printhead movement arrangement being configured such that the printhead is moveable angularly as a result of substantially linear movement of at least one portion of the belt in the belt path.

The printhead movement arrangement may be configured such that the printhead is moveable substantially linearly as a result of substantially linear movement of at least one portion of the belt.

The belt may be a substantially continuous loop. The belt may be a single loop.

The first belt position and the second belt position may be fixed relative to the belt.

The linkage may include a printhead carriage to which the printhead is attached and the printhead may be angularly moveable relative to the carriage.

The printhead carriage may be moveable substantially linearly relative to body of the printing apparatus.

The linkage may be fixedly attached to the belt at the first position on the belt.

The linkage may be pivotally attached to the belt at the second belt position so as to enable angular movement of the printhead.

The printing apparatus may include a monitoring device configured to monitor a force exerted on or by a part of the linkage, and a controller operable to control a position of the printhead using the monitored force.

The printing apparatus may include a monitoring device configured to monitor a position of part of the linkage, and a controller operable to control a position of the printhead using monitored linkage position data.

There is provided a method of operation of a printing apparatus, the printing apparatus including a printhead movement arrangement including a belt and a linkage between the printhead and the belt, the linkage being attached to the belt at two belt positions; the method including:
carrying out a calibration step to determine reference data relating to at least one parameter, the calibration step including moving the printhead between a first printhead position and a second printhead position and determining reference data in the first printhead position and the second printhead position;
storing data indicative of the reference data and/or storing one or more motor control signals required to achieve the printhead position corresponding with the reference data, in data storage;
carrying out one or more printing cycles, including moving the printhead to the second printhead position by:
   executing stored drive control signals and/or monitoring the or each parameter to obtain a current indication of the or each parameter and comparing the current indication of the or each parameter with the corresponding reference data, and continuing movement of the printhead until the current indication of the or each parameter matches the reference data for the second printhead position.

The reference data may include at least one of the following:
a force exerted on or by a part of the linkage;
a position of a part of the linkage;
the position of the printhead in the second position;
a distance moved by the printhead between the first printhead position and the second printhead position;
a printhead angle θ in a print position;
an angle through which the printhead moved between the first printhead position and the second printhead position;
an angle through which the printhead moved between the second printhead position and a third printhead position.

Carrying out the one or more printing cycles may include:
returning the printhead from the second printhead position to the first printhead position by:
   carrying out stored drive control signals for moving the printhead from the first printhead position to the second printhead position substantially in reverse; and/or
   monitoring the or each parameter to obtain a current indication of the or each parameter and comparing the current indication of the or each parameter with the corresponding reference data, and continuing movement of the printhead until the current indication of the or each parameter matches the reference data for the second printhead position.

Carrying out the one or more printing cycles may include moving the printhead between the second printhead position and a third printhead position, and wherein the calibration step includes obtaining reference data relating to the third printhead position storing data indicative of the reference data relating to the third printhead position and/or storing one or more motor control signals required to achieve the printhead position corresponding with the reference data, in data storage.

Carrying out the one or more printing cycles may include returning the printhead from the third printhead position to the second printhead position by
carrying out stored drive control signals for moving the printhead between the second printhead position and the third printhead position substantially in reverse; and/or
monitoring the or each parameter to obtain a current indication of the or each parameter and comparing the current indication of the or each parameter with the corresponding reference data, and continuing movement of the printhead until the current indication of the or each parameter matches the reference data for the second printhead position.

### BRIEF DESCRIPTION OF THE FIGURES

In order that the present disclosure may be more readily understood, preferable embodiments thereof will now be described, by way of example only, with reference to the accompanying drawings, in which:

FIG. 1 is an illustrative cut away view of a printing apparatus;

FIG. 2 is an illustrative perspective view of part of a printing apparatus, showing a printhead and a printhead movement arrangement;

FIG. 3 is a part-exploded perspective view of the printhead and the printhead movement arrangement of FIG. 2;

FIG. 4 is an illustrative perspective view of a part of a printing apparatus showing a printhead and a printhead movement arrangement;

FIG. 5 is an illustrative side view of parts of a printing apparatus and a substrate support, indicating an angle subtended between a printhead of the apparatus and the substrate support;

FIG. 6A is an illustrative side view of parts of a printing apparatus and a substrate support, showing a printhead in a park position;

FIG. 6B is an illustrative side view of parts of a printing apparatus and a substrate support, showing the printhead in a prime position;

FIG. 6C is an illustrative side view of parts of a printing apparatus and a substrate support, showing the printhead in a printing position;

FIG. 7 is an illustrative side view of parts of a printing apparatus showing the printhead in three different positions; and

FIG. 8 is an illustrative side view of a printhead, a printhead carriage and parts of a linkage of a printhead movement arrangement, with the printhead and the linkage in two positions relative to the printhead carriage.

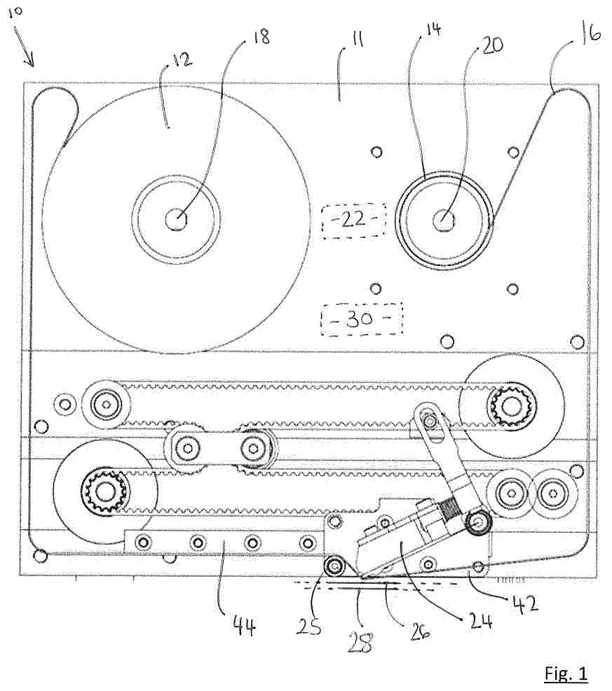

### DETAILED DESCRIPTION OF THE DISCLOSURE

We provide methods of controlling a printer as described herein, and a printing apparatus configured to operate in accordance with one or more aspects of the methods described.

Referring to the figures, there is shown a printing apparatus 10, having a main chassis or body 11 housing a first spool 12, and a second spool 14 of inked ribbon or tape 16. Each of the spools 12, 14 is mounted on a respective spindle 18, 20. Each of the first spindle 18 and the second spindle 20 may be driven by a ribbon drive apparatus 22, which may include one or more motors. Rotation of each spindle 18, 20 causes rotation of the respective spool 12, 14, and may be controlled so as to transfer ribbon 16 from one of the first spool 12 and the second spool 14, to the other of the first spool 12 and the second spool 14. Spools 12, 14 of ribbon 16 may be provided in a cassette, to enable easy installation and/or replacement of the ribbon 16. Ribbon 16 may be transferred in two directions, i.e. a forward direction and a reverse direction, between the spools 12, 14. The rotation of the or each spindle 18, 20 and/or spool 12, 14 may be controlled and/or monitored in any appropriate way, for example in accordance with known methods, for example by a single motor, or a respective motor for each spindle 18, 20, etc., The printing apparatus 10 may be a print and apply printing apparatus, e.g. operable to print labels for application to another object, or may be operable to print directly on to product packaging, e.g., “overprinting”.

The ribbon drive apparatus 22 is operable to transfer ribbon 16 between one of the first and second spools 12, 14 and the other of the first and second spools 12, 14, past a printhead 24. The printhead 24 may include a plurality of energisable printing elements, for example thermally energisable printing elements, which may be selectively operable to transfer ink from the ribbon 16 to a substrate 26. The substrate 26 may be a roll of material, for example paper, film, e.g., biaxially oriented polypropylene, labels, etc., The substrate 26 may be provided as discrete items to be printed, e.g., labels, as in “print and apply” applications.

The substrate 26 may be supported adjacent the printhead 24 by a substrate support 28. The substrate support 28 may be a platen roller, or a substantially planar platen, for example. The substrate support 28 may be driven by a substrate drive apparatus, for example a motor, to advance the substrate 26 in a substrate path. It will be appreciated that the substrate drive apparatus need not be positioned in the substrate support 28 and/or need not drive the substrate support 28 directly. The substrate support 28 may be rotated to move the substrate 26 relative to other parts of the printing apparatus 10, for example the printhead 24. The substrate drive apparatus may be operable to advance the substrate 26 into a printing position adjacent the printhead 24. A peel off roller 25 may be provided to separate the ribbon 16 from the substrate 26 after a printing operation has been carried out.

The printing apparatus 10 may include a controller 30. The controller 30 may be operable to control one or more functions of the printing apparatus 10. For example, the controller 30 may be operable to control the movement of the ribbon 16, for example by controlling the ribbon drive apparatus 22, movement of the printhead 24, and/or the energization of printing elements of the printhead 24. The controller 30 may be operable to monitor parameters and/or functions of the printing apparatus 10. The controller 30 may be operable to receive signals which are indicative of functions and/or parameters of the printing apparatus 10.

The controller 30 may include data storage for example memory. The data storage may be configured to store one or more commands, one or more routines or programs, and/or operation data of the printing apparatus 10, for example. The data storage may include read only memory and/or read/write memory as appropriate.

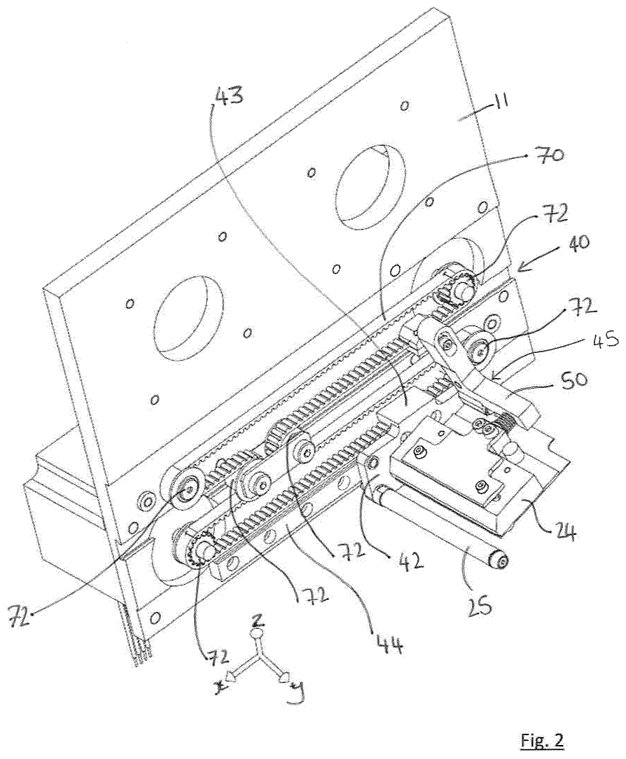

The printing apparatus 10 may include a printhead movement arrangement 40, for example as shown in FIG. 2. The printhead movement arrangement 40 is configured to move the printhead 24 relative to the body 11. The printhead movement arrangement 40 may be configured to move the printhead 24 towards and away from the ribbon 16 and/or the substrate 26 and/or the substrate support 28 (in the direction of the z-axis shown in FIG. 2). Additionally or alternatively, the printhead movement arrangement 40 may be configured to move the printhead 24 along a second axis that is substantially parallel with the direction of substrate and/or ribbon movement (the x axis as shown in FIG. 2). The printhead movement arrangement 40 may be operable to move the printhead substantially linearly along the first and/or second axes (z, x).

The printhead movement arrangement 40 is configured to enable angular, e.g. pivotal movement of the printhead 24. Angular movement of the printhead 24 may be used to move the printhead between a prime position and a printing position, for example. The angular movement of the printhead 24 may be used to move the printhead 24 towards and/or away from the substrate and/or substrate support and/or the ribbon 16.

The printhead 24 may be moveable along the first and second axes in an intermittent mode. In intermittent mode, the printhead 24 is moved towards the substrate support, to sandwich the ribbon 16 between the printhead 24 and the substrate 28, and to press the ribbon 16 into contact with the substrate 26. The printhead is then moved along the x-axis during a printing operation, with the ribbon pressed against the substrate 26 by the printhead 24, and then at the end of the printing operation, the printhead 24 is moved substantially in the z direction, away from the substrate 26, and/or the ribbon 16 and/or the substrate support 28.

The printhead 24 may also be moveable generally along the first and second axes in a continuous printing mode—the movement along the second (x) axis being possible to correctly position the printhead 24 relative to the printing surface (e.g. the substrate support 28). In continuous printing mode, such movement would typically be carried out before printing operations begin, for example when the printhead 24 is in its park position, whereas in intermittent printing mode, such movement along the axis is carried out during a printing operation, between a “start of print” position and an “end of print” position, to carry out the print, and to return the printhead 24 to the “start of print” position when a print is complete.

The printhead movement arrangement 40 includes a belt 70. The printhead movement arrangement includes a single belt 70. The belt 70 is arranged in a belt path. The belt path may be a substantially continuous loop.

The belt 70 may be arranged in the belt path around belt guides 72. One or more of the belt guides 72 may be rotatable. One or more of the belt guides 70 may be driven, for example by a belt drive apparatus. One or more of the belt guides 72 may be a pulley. One or more of the belt guides may be toothed or splined. One or more of the belt guides 72 may be mounted on a part of the body 11.

The belt 70 may be moveable by at least one motor. The belt drive apparatus 70 may include one or more motors 74, 76. The belt 70 may be moveable by a pair of motors 74, 76. Each motor 74, 76 may be operable to drive a corresponding belt guide 72.

The belt 70 may be arranged around a first pair of belt guides 72a, 72b. Each one of the first pair of belt guides 72a, 72b is driven by a respective motor 74, 76. A control signal may be provided to each of the motors 74, 76, for example by the controller 30, to control the operation of each motor 74, 76, to rotate the respective belt guide 72a, 72b. The position of each of the first pair of belt guides 72a, 72b may be substantially fixed relative to the body 11.

The belt 70 may be arranged around a second pair of belt guides 72c, 72d. Each one of the second pair of belt guides 72c, 72d may be rotatable by movement of the belt 70. Each of the second pair of belt guides 72c, 72d may be mounted on the body 11, for example by a respective fixing, e.g. a screw, about which the belt guide 72c, 72d is rotatable relative to the body 11. The position of each of the second pair of belt guides 72c, 72d may be substantially fixed relative to the body 11.

Each driven belt guide 72a, 72b may be spaced from a non-driven belt guide 72c, 72d along the x axis.

The belt may be arranged around a third pair of belt guides 72e, 72f. Each one of the third pair of belt guides 72e, 72f may be moveable substantially linearly relative to the body 11. Each one of the third pair of belt guides 72e, 72f may be moveable along the second axis, for example in a direction substantially parallel to the substrate/ribbon path (the x-axis) relative to the body 11. Each of the third pair of belt guides 72e, 72f may have a substantially smooth outer surface which contacts the belt 70. The third pair of belt guides 72e, 72f may be connected together and moveable together relative to the body 11. The third pair of belt guides 72e, 72f may form part of a slide assembly 73 when they are connected together. The third pair of belt guides 72e, 72f may be connected together by a first connecting element 73a, which may be a plate, for example. The slide assembly 73 may include a second connecting element, for example a plate, which is moveable substantially linearly relative to the body 11. The slide assembly 73 may be moveable along a channel 15 in the body 11 or a track attached to the body 11, for example. One or more bearings may be provided to reduce friction between the slide assembly and the body 11.

The belt 70 has two faces: an inner face and an outer face. One or both faces of the belt 70 may be toothed. The first and second pairs of belt guides 72a, 72b, 72c, 72d may be positioned adjacent the inner face of the belt 70. The third pair of belt guides 72e, 72f may be positioned adjacent the outer face of the belt 70, as shown in FIG. 2, for example.

The belt 70 enables movement of the printhead 24 at least along the second axis (x-axis), i.e. in a direction substantially parallel to the substrate/ribbon path.

The printhead movement arrangement 40 may include a printhead carriage 42. The printhead 24 may be mounted on the printhead carriage 42. The printhead carriage 42 may be engageable with and moveable relative to a carriage support 44, for example a rail. The carriage support 44 may be configured to guide movement of the printhead carriage 42 (and the printhead 24) along the x-axis, i.e. substantially parallel to the substrate/ribbon path. The carriage support 44 may be substantially linear. The carriage support may be mounted on the body 11. The printhead carriage 42 may include an engagement member configured to engage with the carriage support 44 and to enable such movement. The engagement member may be a bracket, for example a clamping bracket. The peel off roller 25 may be provided on the printhead carriage 42.

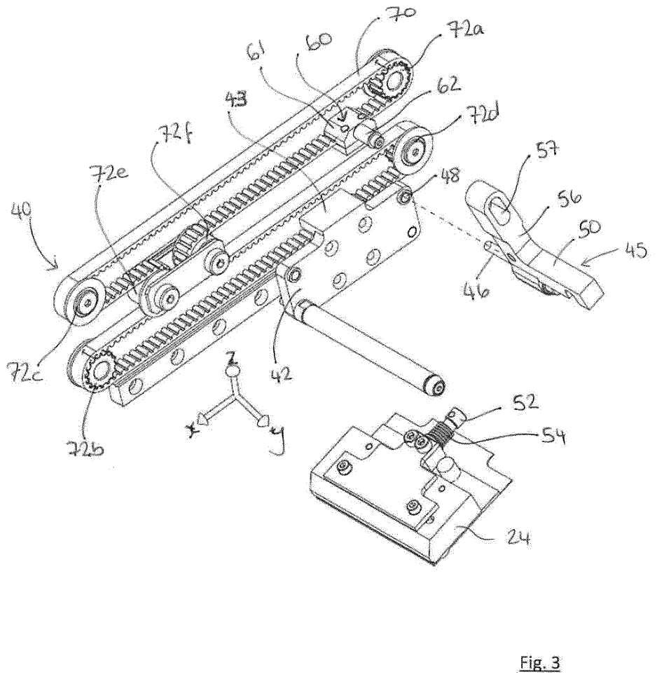

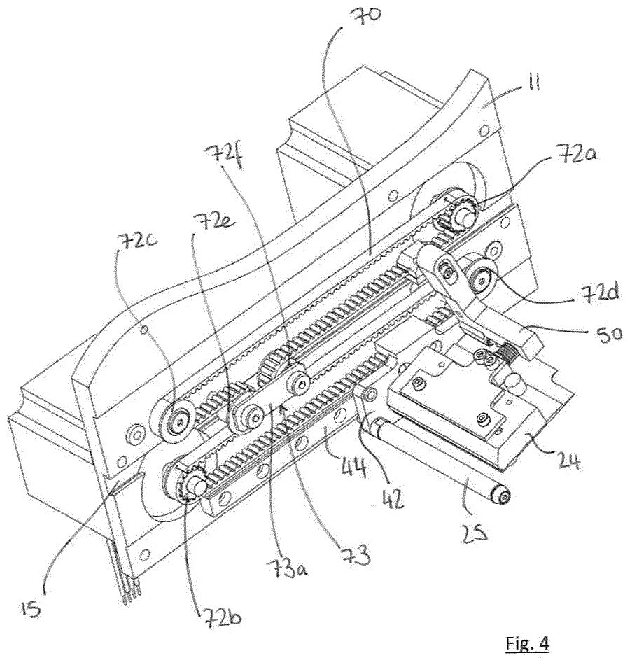

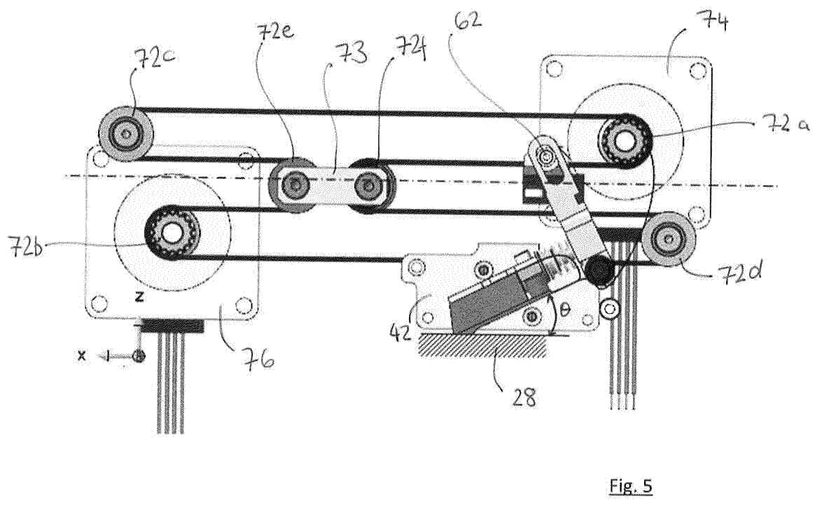

Referring to FIG. 3, for example, the printhead 24 may be mounted on the printhead carriage 42. The printhead 24 may be moveable relative to the printhead carriage 42. The printhead 24 may be pivotally mounted on the carriage 42. The printing apparatus 10 may include a pivoting arrangement that enables the printhead 24 to pivot relative to the printhead carriage 42. The pivoting arrangement may include a connecting member 46. The connecting member 46 may include a pin about which the printhead 24 is able to pivot relative to the printhead carriage 42. The connecting member 46 may be engageable with, for example receivable in, a formation 48 of the carriage 42. In the example shown the pin 46 is receivable in an opening 48. The printhead 24 may be pivotable relative to the printhead carriage 42 about the pin 46.

The printhead 24 may be connected to the belt 70. The printhead 24 may be connected to the belt 70 at two positions on the belt 70, as will be explained in more detail below.

The printhead 24 may be connected to the belt 70 by a linkage 45. The printhead carriage 42 may be a part of a linkage 45 that connects the printhead 24 to the belt 70. The linkage 45 may extend between two positions on the belt 70.

The linkage 45 may include a first connection 43 to the belt 70. The first connection 43 may be between the printhead carriage 42 and the belt 70 at a first position on the belt 70. The first connection 43 between the printhead carriage 42 and the belt 70 at the first position on the belt 70 may be a substantially fixed connection, such that movement of the belt 70 causes corresponding movement of the part of the printhead carriage 42 connected to the belt 70 at the first position. The first connection 43 may include any appropriate connection member, for example a bracket, a hook, a clip, a clamp, an engagement formation that corresponds with a formation of the belt 70, etc. The position of the first connection on the belt 70 may be between the second guide member 72b and the fourth guide member 72d, for example, between a motor driven guide member 72 and a non-driven guide member 72. The position of the first connection 43 may be positioned on a portion of the belt 70 that is the closest portion of the belt path to the substrate support 28. The first connection may be positioned on a portion of the belt 70 configured to move along the second axis—i.e. substantially parallel with the direction of travel of the ribbon 16 and/or the substrate 26.

The linkage 45 may include a second connection 60 with the belt 70. The second connection 60 may be positioned at a second position on the belt 70. The position of the second connection 60 may be fixed relative to the belt 70. The second connection belt attachment member 60 may be attached to the belt 70 between one of the first pair of belt guides 72a, 72b (i.e. one of the motor-driven belt guides 72), and one of the third pair of belt guides 72e, 72f (i.e. one of the linearly moveable belt guides 72). The second connection 60 may be positioned on a portion of the belt 70 between the first driven guide member 72a and the slide assembly 73.

The second connection 60 between the linkage 45 and the belt 70 may be a pivotal connection. The second connection may include a fixed part 61 that is fixed relative to the belt 70. The fixed part 61 may be a bracket, a clip, a clamp, a hook, an engagement formation that is engageable with a corresponding formation of the belt, etc., and/or any other appropriate connection.

The linkage 45 may include a pivoting arrangement. The pivoting arrangement may be arranged to enable at least part of the linkage to pivot relative to the fixed part 61 of the second connection 60.

The pivoting arrangement may be arranged to enable the linkage to pivot relative to the printhead carriage 42.

The pivoting arrangement may include a beam 50. The beam 50 may be coupled to the printhead carriage 42. The beam 50 may be pivotable relative to the printhead carriage 42. The beam 50 may be pivotable relative to the printhead carriage 42 about a pivot pin. The beam 50 may be pivotable relative to the printhead carriage 42 about the connecting member 46. The connecting member 46 may be attached to or integral with the beam 50.

The beam 50 may be connected to the second attachment 60. The beam 50 may be angularly moveable, e,g, pivotable relative to the second connection 60. The beam 50 may be angularly moveable relative to the fixed part 61 of the second connection 60. The beam 50 may be connected to the second connection 60 by a pin 62. The pin 62 may be receivable in an opening 57 in the beam 50. In the example shown, the opening 57 is provided in an arm 56. The arm 56 may extend substantially perpendicularly relative to the beam 50. The arm 56 may be substantially rigid. The arm 56 may be integrated as part of the beam 50, or attached thereto in a suitable manner. The opening 57 may be an elongate slot, to enable the conversion of substantially linear movement to angular movement of the printhead 24. The arm 56 may be able to rotate about the pin 62, causing corresponding angular movement of the beam 50.

The printhead 24 may be coupled to the beam 50 by a coupling arrangement. The coupling arrangement may include a connecting member 52. The connecting member 52 may be a rod. The coupling arrangement may include a biasing member 54 configured to bias the printhead 24 against the beam 50. The printhead 24 may be pivotable relative to the carriage 42, as explained above, for example about the connecting member 46 between the beam 50 and the printhead carriage 42. The connecting member 46 may be part of the pivoting arrangement.

A strain gauge 58 may be fixed to the beam 50, for example to the arm 56. The beam 50 (e.g. the arm 56) may include a recess or notch 60 opposite the position of the strain gauge 58. The recess 60 may be machined. This arrangement enables the beam 50 (or a part of the beam 50, for example the arm 56) to act as a load cell.

In use, rotating both the first motor 74 and the second motor 76 with substantially equal speeds in the same direction, causes the first belt connection 43, and hence the printhead carriage 42, and the second belt connection 60 to move along the x-axis. In this situation, the printhead carriage 42 and the second belt connection 60 (which may carry the pin 62) may move a substantially equal distance. Such movement along the x-axis may be used during printing in the intermittent mode and/or to position the printhead 24 relative to the printing surface, e.g. the substrate support 28 in continuous or intermittent mode.

Rotating one of the motor-driven belt guides 72, for example the motor driven belt guide 72 closest to the second belt connection 60 (in the example shown, the belt guide 72a driven by the first motor 74) whilst not rotating the other motor-driven belt guide 72b (i.e. by not operating the other motor, in this case the motor 76) causes the fixed part 61 of the second belt connection 60 (and the pin 62 carried by the fixed member 61) to travel right or left along the x-axis, dependent on the rotational direction of the motor 74 and the corresponding belt guide 72a, such that the linkage 45, in particular the pivoting arrangement, moves the printhead 24 towards or away from the printing surface, for example the substrate support 28. In the example shown the arm 56 and the beam 50 are caused to rotate about the pin 46, and consequently rotate the printhead 24, altering a printhead angle θ subtended between the printhead 24 and the printing surface, which may have the effect of moving the printhead 24 towards or away from the printing surface, for example the substrate support 28.

Rotating both motors 74, 76 with different speeds may result in linear translation of the printhead carriage 42 along the x-axis and/or angular movement of the printhead 24. The angular movement of the printhead 24 is caused by the relative movement of the two belt connections 43, 60 along the second axis x, which causes rotation of the beam 50 about the pin 46. The angular movement of the linkage 45 may cause movement of the printhead 24 in along the z axis.

This arrangement enables both linear movement and rotational (pivoting) movement of the printhead 24 within the limited space available between the belt guides 72.

With the present arrangement, the position of a part of the printhead 24, for example a tip of the printhead 24 bearing the printing elements, in relation to the printing surface, e.g. the substrate support 28 can be controlled in the x and z axes as well as an angle θ of the printhead 24 in relation to the printing surface. Only a single belt 70 is required. The angle θ may be subtended between a lower surface of the printhead 24, and an upper surface of the substrate support (i.e. the printing surface), or, where the substrate support 28 is curved, a tangent struck at the printing surface, that is substantially parallel with the x-axis, for example. The printhead angle θ may be subtended between a surface of the printhead 24 and a part of the printhead carriage 42.

A method of operation of the printing apparatus 10 will be described.

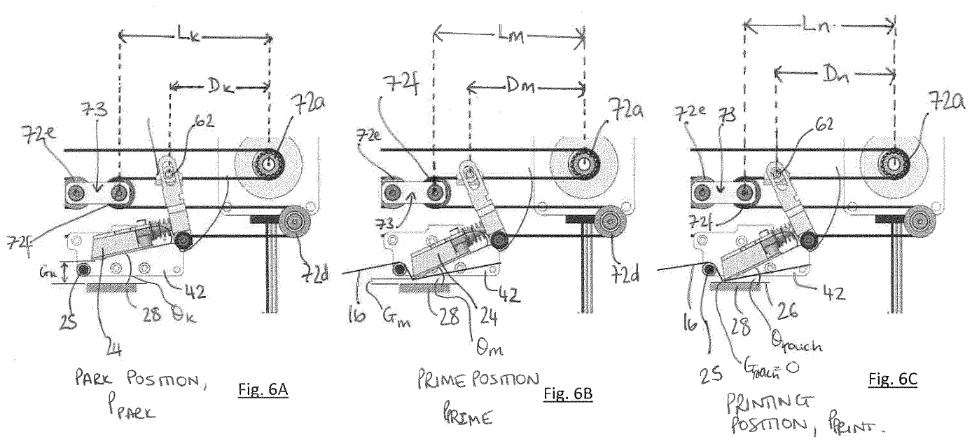

Referring to FIG. 6A, at the start-up of the operation, for example, the ribbon 16 may be loaded into the printing apparatus 10, for example using a cassette. At this stage, the printhead 24 may be in a first, position relative to the substrate support 28. The first position of the printhead 24 may be a retracted or “park” position P_{PARK}. The distance between the substrate support 28 and the printhead 24 in the first position is a gap Gk. The printhead angle θ is expressed as Ok. The printhead 24 may be positioned generally above the peel roller 25, i.e. along the z-axis, but need not be aligned with the peel roller 25 along the x-axis. The purpose of the gap GK is to clear the path in front of the ribbon 16 during the loading or unloading of the ribbon 16 (and cassette, where provided). In the first, park position P_{PARK}, the centre of one of the third pair of (moveable) belt guides 72e, 72f is positioned at a longitudinal distance Lk from the centre of the first, driven belt guide 72a (which may also be the centre of the first motor 74). The distance Lk may be the distance between the centre of the first driven belt guide 72a (which may be concentric with the first motor 74) and the nearest moveable belt guide 72f to the first motor 74, i.e. the nearest belt guide 72f of the slide assembly 73 to the fixed position, driven belt guide 72a. The second belt connection 60 (and in this case the pin 62) is positioned a distance Dk from the centre of the first driven belt guide 72a.

Referring to FIG. 6B, the printhead 24 is in a second position (a prime position P_{PRIME}) relative to the substrate support 28. The printhead 24 has been moved closer to the substrate support 28, for example after the ribbon 16 has been loaded, such that the longitudinal distance (i.e. along the z-axis) between the printhead 24 and the substrate support 28 is a gap Gm (which may be between 1 and 2 mm). The gap Gm is smaller than the gap Gk. The distance along the x-axis between the second connection 60 (e.g. the pin 62) and the centre of the driven belt guide 72a in the prime position P_{PRIME} is a distance Dm. The distance along the x-axis between the driven belt guide 72a and the moveable belt guide 72f is a distance Lₘ. The printhead angle θ (shown between the printhead 24 and the printing surface in FIG. 6A) is Om. In the second, prime position P_{PRIME}, the printhead 24 may be in contact with the ribbon 16, and/or the tip of the printhead 24 may be positioned below the peel off roller 25 (along the z-axis).

To achieve the second position P_{PRIME}, the first motor 74 may be operated to rotate the first belt guide 72a clockwise, while the second motor 74b is stationary. This mode of operation causes the second belt connection 60 (and the pin 62) to move along the x-axis (in FIG. 6B, the printhead 24 has moved to the left relative to the substrate support 28).

The distance travelled along the x-axis between P_{PARK} and P_{PRIME} may be expressed as follows:

$${X}_{k \to m} = - ( {D}_{m} - {D}_{k} ) \qquad where {D}_{m} > {D}_{k}$$

The slide assembly 73 will travel half of the distance X_{k→m} which may be expressed as follows:

$${L}_{m} = {L}_{k} + \frac{D m - D k}{2}$$

The first motor 74 may be rotated so as to bring the printhead 24 into contact with the printing surface (e.g. the substrate support 28). This is the printing position P_{PRINT}. The distance along the x-axis between the second belt connection 60 (e.g. the pin 62) and the centre of the driven belt guide 72a in the print position P_{PRINT} is a distance Dₙ. The distance along the x-axis between the driven belt guide 72a and the belt guide 72f is a distance Ln. It will be appreciated that the printhead 24 will not directly touch the substrate support 28 during a printing operation, since the printhead 24 needs to press the ribbon 16 against the substrate 26, both of which are sandwiched between the printhead 24 and the substrate support 28. A predetermined pressure to be applied by the printhead 24 on the printing surface may be selected. The distance X_{m→n} travelled along the x-axis between P_{PRIME} and P_{PRINT} may be expressed as follows:

$${X}_{m \to n} = - ( {D}_{n} - {D}_{m} ) \qquad where {D}_{n} > {D}_{m}$$

And the slide assembly 73 will travel half of the distance X_{m→n}, such that the distance Lₘ may be expressed as follows:

$${L}_{n} = {L}_{m} + \frac{D n - D m}{2}$$

The remaining distance Dₙ between the second belt connection 60 (e.g. the pin 62) and the centre of the driven belt guide 72a may be used for the printing part of the cycle-during which the printhead carriage 42 is moved relative to the body 11, so as to move the printhead 24 relative to the printing surface, and then returning the printhead 24 to the prime position P_{PRIME}.

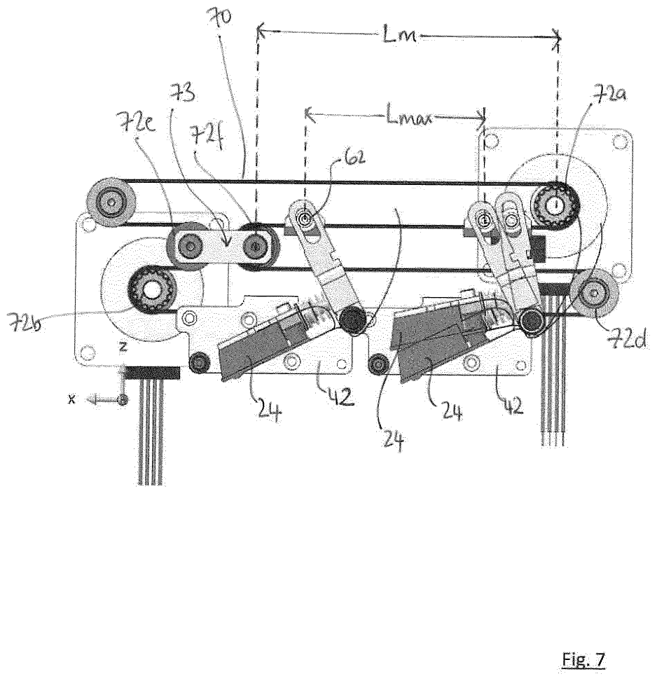

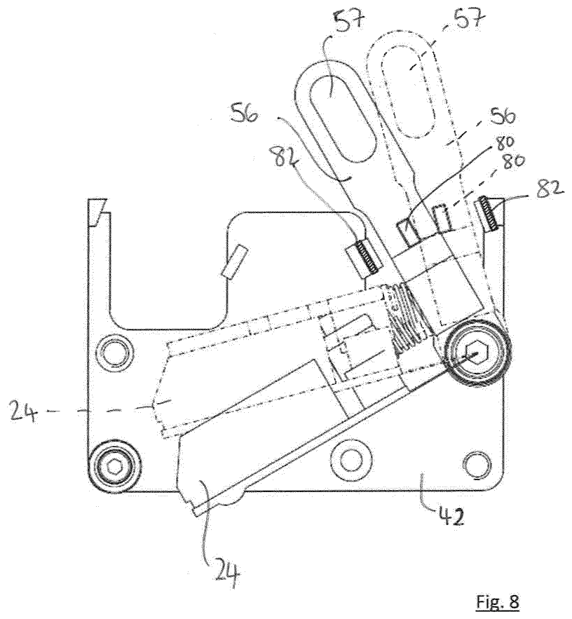

FIG. 7 shows the maximum printing length Lₘₐₓ available with some margins for overtravel:

$${L}_{max} - ( {D}_{n} - {D}_{k} ) - ( {R}_{p 1} + {R}_{p 2} )$$

where: Rₚ₁ and Rₚ₂ are the radii of the driven belt guide 72a and the belt guide 72f (the closest belt guide 72 of the slide assembly 73 to the first driven belt guide 72a), respectively.

The position of the printhead 24 relative to the printing surface (e.g. the substrate support 28) may be controlled, for example by the controller 30.

The printhead angle θ may be controlled. The printhead angle θ may be controlled by the controller 30, for example.

The pressure exerted between the printhead 24 and the printing surface (e.g. the substrate support 28) may be controlled, for example by the controller 30.

A torsion spring may be added to the connecting member 46 between the carriage 42 and beam 50. As the carriage 42 moves a torque will be exerted on the arm 56 with an equivalent reaction from the second belt connection 60 (e.g. the pin 62) on the belt 70. This torque force may be sensed by the strain gauge 58 mounted on the arm 56. The measured force can be used to calibrate an angle between the arm 56 and the carriage 2. As a result, it may be possible to achieve and/or maintain a reference position for the park position P_{PARK} and priming position P_{PRIME} of the printhead 24. By knowing the gap Gm between the priming position P_{PRIME} of the printhead 24 and the substrate support 28 (e.g. the platen surface), one or both of the motors 74, 76 may be driven a pre-defined amount, for example a pre-defined number of steps, in the appropriate direction to arrive at the printing position of the printhead 24 with relatively optimized pressure. Calibration may be carried out to obtain a corresponding torque value associated with one or more printhead positions. A torque-position relationship may be known, determined, verified, and/or adjusted. Once each desired position, e.g. park, prime, and/or print, has an associated torque value, the movement of the printhead 24 may be controlled in accordance with the associated torque value, measured by the strain gauge 58. Movement of one or both of the motors 74, 76 may also be calibrated to achieve the or each desired position. The controller 30 may be operable to control the or each motor 74, 76 to move the belt 70 and hence the printhead carriage 42 into the desired position. The torque of the arm 56 may be monitored, using the strain gauge, to determine when the printhead 24 has reached the desired position. Additionally or alternatively, the movement of the motor(s) 74, 76 may be monitored, such that once a pre-defined motor movement has been carried out, to achieve the associated torque (on the arm 56), it may be assumed that the printhead has reached the associated (desired position). Thus, the position of the printhead 24 may be determined indirectly by monitoring a torque on a part of the connection between the printhead carriage and the belt 70, for example the arm 56.

Additionally or alternatively, a position sensor 80, for example a Hall effect sensor, may be provided. The sensor 80 may be positioned on the arm 56 and a magnet 82 may be positioned nearby, for example. In the example shown, a pair of magnets 82 are positioned on the carriage 42. The position sensor may be used to measure the distance between the centre of the arm 56 and the or each magnet 82. Relative distances between the position sensor 80 and each magnet 82, where more than one magnet 82 is provided, may be determined. An alternative arrangement of the position sensor may be to position the sensor 80 in a substantially fixed angular position, for example on the printhead carriage 42, and for one or more magnets to be provided on the printhead 24, a part of the beam 50 or the arm 56, for example.

Since the location of the position sensor 80 relative to the printhead 24 is known, using the position sensor 80, the position of the printhead 24 can be determined. Additionally or alternatively, the printhead angle θ may be calculated. The printhead angle θ may be the angle subtended between a surface of the printhead 24 and the print surface (e.g. an upper surface of the substrate support 28, or a tangent struck at the printing position on a curved substrate support, e.g. a top dead centre of the substrate support 28), or the printhead angle θ may be the angle subtended between a surface of the printhead 24 and a part of the printhead carriage 42—for example a front surface of the carriage 42 or a lower surface of the carriage 42.

As explained above, the printhead angle θₘ is subtended when the printhead 24 is in the prime position P_{PRIME}. θ_{TOUCH} is the angle through which the printhead 24 needs to move between the prime position P_{PRIME} and a touch position P_{TOUCH}, when the printhead contacts the printing surface. The gap G_{TOUCH} between the printhead and the printing surface in the touch position P_{TOUCH} is zero. θ_{PRESSURE} is an angle through which the printhead 24 is moved to achieve a desired printing pressure, i.e. a pressure exerted by the printhead 24 on the printing surface during printing. The controller 30 may be operable to continue adjusting the printhead angle θ after the touch position P_{TOUCH} has been achieved. An angle θ_{PRINT} is the angle through which the printhead moves between the prime position P_{PRIME} and the printing position P_{PRINT}. The angle θ_{PRINT} may be expressed as follows:

$${θ}_{P R I N T =} {θ}_{TOUCH} + {θ}_{PRESSURE}$$

It is desirable to maintain a substantially constant printing pressure between the printhead 24 and the printing surface during a printing operation. The printing pressure may be achieved by maintaining a substantially constant printhead angle θ during printing. The printing pressure may be a function of (and determined by) the substrate support surface hardness and denting movement in the z-axis (or associated θ_{PRESSURE}).

The control of the printing pressure may be achieved as follows:

### Carry Out Calibration:

a) move the printhead from the prime position P_{PRIME} into the desired print position P_{PRINT};
b) determine reference data using the position sensor 80 and/or the strain gauge 56, the reference data including at least one of the following:
   i. the position of the printhead 24 in the print position P_{PRINT},
   ii. the distance moved by the printhead 24 between the prime position P_{PRIME} and the print position P_{PRINT};
   iii, the printhead angle θ in the print position;
   iv. the angle θ_{PRESSURE} through which the printhead 24 moved between contacting the printing surface and achieving the print position P_{PRINT};
   v. the angle θ_{PRINT} through which the printhead 24 moved between the prime position P_{PRIME} and the print position P_{PRINT};
c) store data indicative of the reference data and/or store one or more motor control signals required to achieve the reference data, in memory, for example memory of the controller 30.

Carry out one or more printing cycles, including moving the printhead 24 between the prime position P_{PRIME} and the printing position P_{PRINT} by:
a) monitoring at least one of:
   i. the position of the printhead 24;
   ii. the distance moved by the printhead 24;
   iii, the printhead angle θ;
   iv. the angle through which the printhead 24 has moved; and
b) comparing the monitored datum/data with the reference data; and/or
c) operating one or both of the motors 74, 76 in accordance with the motor control signals determined in the calibration process;
d) returning the printhead 24 to the prime position P_{PRIME}, either by
   i. monitoring the position of the printhead, and/or the distance moved by the printhead and/or the angle through which the printhead moves; and/or
   ii. operating one or both of the motors 74, 76 in reverse (compared with the signals provided to move the printhead 24 from the prime position P_{PRIME} to the print position P_{PRINT}) or in accordance with signals determined in the calibration process.

The position sensor 80 and/or the strain gauge 58 may be used to determine when the printhead is in the prime position P_{PRIME}.

It will be understood that the printhead may have any appropriate number of positions relative to the ribbon and/or the substrate and/or the substrate support.

The present arrangement extends the control of movement beyond pure Cartesian movement in the x and z axes, to include the ability to control the printhead angle θ between the printhead and the printing surface (or an angle indicative of the printhead angle θ).

The new arrangement is compact compared with prior art solutions.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A printing apparatus including a printhead and a printhead movement arrangement, the printhead movement arrangement including a belt moveable in a belt path, and a linkage between the printhead and the belt, wherein the linkage is attached to the belt at a first belt position and a second belt position, the printhead movement arrangement being configured such that linear movement of at least one portion of the belt in the belt path causes angular movement of the printhead.

2. A printing apparatus according to claim 1 wherein the printhead movement arrangement is configured such that linear movement of at least one portion of the belt causes linear movement of the printhead.

3. A printing apparatus according to claim 1 wherein the belt is a continuous loop.

4. A printing apparatus according to claim 1 wherein the first belt position and the second belt position are fixed relative to the belt.

5. A printing apparatus according to claim 1 wherein the linkage includes a printhead carriage to which the printhead is attached such that the printhead is angularly moveable relative to the carriage.

6. A printing apparatus according to claim 5 wherein the printhead carriage is moveable linearly relative to a body of the printing apparatus.

7. A printing apparatus according to claim 1 wherein the linkage is fixedly attached to the belt at the first belt position.

8. A printing apparatus according to claim 1 wherein the linkage is pivotally attached to the belt at the second belt position so as to enable angular movement of the printhead.

9. A printing apparatus according to claim 1 including a monitoring device configured to monitor a force exerted on or by a part of the linkage, and a controller operable configured to control a position of the printhead using the monitored force.

10. A printing apparatus according to claim 1 including a monitoring device configured to monitor a position of part of the linkage, and provide monitored linkage position data to a controller, the controller being configured to control a position of the printhead using the monitored linkage position data.

11. A method of operation of a printing apparatus including:
carrying out a calibration step to determine reference data relating to at least one parameter, the calibration step including moving a printhead between a first printhead position and a second printhead position and determining reference data in the first printhead position and the second printhead position;
storing data indicative of the reference data and/or storing one or more motor control signals required to achieve a printhead position corresponding with stored reference data, in data storage;
carrying out one or more printing cycles using the printhead, including moving the printhead to the second printhead position by:
executing stored drive control signals and/or monitoring the or each parameter to obtain a current indication of the or each parameter and comparing the current indication of the or each parameter with corresponding data from the reference data, and continuing movement of the printhead until the current indication of the or each parameter matches the reference data for the second printhead position.

12. A method according to claim 11 wherein the reference data includes at least one of the following:
a force exerted on or by a part of the linkage;
a position of a part of the linkage;
the position of the printhead in the second position;
a distance moved by the printhead between the first printhead position and the second printhead position;
a printhead angle in a print position;
an angle through which the printhead moved between the first printhead position and the second printhead position; or
an angle through which the printhead moved between the second printhead position and a third printhead position.

13. A method according to claim 11 wherein carrying out the one or more printing cycles includes:
returning the printhead from the second printhead position to the first printhead position by:
carrying out stored drive control signals for moving the printhead from the first printhead position to the second printhead position in reverse; and/or
monitoring the or each parameter to obtain a current indication of the or each parameter and comparing the current indication of the or each parameter with corresponding data from the reference data, and continuing movement of the printhead until the current indication of the or each parameter matches the reference data for the second printhead position.

14. A method according to claim 11 wherein carrying out the one or more printing cycles includes moving the printhead between the second printhead position and a third printhead position, and wherein the calibration step includes obtaining reference data relating to the third printhead position, storing data indicative of the reference data relating to the third printhead position and/or storing one or more motor control signals required to achieve the third printhead position corresponding with the reference data, in data storage.

15. A method according to claim 14 wherein carrying out the one or more printing cycles includes returning the printhead from the third printhead position to the second printhead position by
carrying out stored drive control signals for moving the printhead between the second printhead position and the third printhead position in reverse; and/or
monitoring the or each parameter to obtain a current indication of the or each parameter and comparing the current indication of the or each parameter with corresponding data from the reference data, and continuing movement of the printhead until the current indication of the or each parameter matches the reference data for the second printhead position.

16. A printing apparatus according to claim 1 being a thermal transfer printer.

17. A printing system including a printing apparatus including a printhead and a printhead movement arrangement, the printhead movement arrangement including a belt moveable in a belt path, and a linkage between the printhead and the belt, wherein the linkage is attached to the belt at a first belt position and a second belt position, the printhead movement arrangement being configured such that linear movement of at least one portion of the belt in the belt path causes angular movement of the printhead, the printing system further including a ribbon carrying marking medium that the printhead is configured to transfer to a substrate.

18. A printing system according to claim 17 including a ribbon drive apparatus.
